(19) United States
(12) Patent Application Publication
(10) Pub. No.: US 2026/0135729 A1
(43) Pub. Date: May 14, 2026

(54) BASE COLLABORATION SYSTEM AND PLATFORM

(71) Applicant: HITACHI HIGH-TECH CORPORATION, Minato-ku, Tokyo (JP)

(72) Inventors: Tooru ARAMAKI, Tokyo (JP); Go SAITO, Tokyo (JP); Xicen ZHANG, Tokyo (JP); Mihoko KIJIMA, Tokyo (JP); Takefumi KAKINUMA, Tokyo (JP)

(21) Appl. No.: 18/692,050

(22) PCT Filed: Apr. 5, 2023
(86) PCT No.: PCT/JP2023/014023

§ 371 Date: Mar. 14, 2024

(51) Int. Cl. H04L 12/22; H04L 12/66

(52) U.S. Cl. CPC H04L 12/22; H04L 12/66

(57) ABSTRACT

A base collaboration system of the invention that accesses a second base different from a first base from the first base where a first computer and a second computer are disposed, and acquires published data of the second base, in which an arrival route to reach the published data is set by the first computer, where a device on the arrival route is permitted to communicate with the published data, and the published data is accessed by the second computer, in which a server in the first base has an area where the published data is stored, where the second computer copies the published data to the area or refers to the published data, and in which communication between a base other than the first base and the area is prohibited by the first computer.

### TECHNICAL FIELD

The present invention relates to a base collaboration system and a platform.

### BACKGROUND ART

Evaluation and manufacturing of a single process in semiconductor manufacturing is generally carried out by collaboration and division of labor at a plurality of bases. Progress management data or production data of a certain process in semiconductor manufacturing at one base is confirmed at another base and is utilized to improve operating rates and production rates. In order to coordinate operations between the plurality of bases in this way, it is necessary to share data between the bases. However, such data is highly confidential and cannot be disclosed to external networks. Mutual confirmation of the data between the bases requires security measures.

As a technology for viewing data from a remote location, PTL 1 discloses a system that monitors products deployed on a movable platform and distributes data regarding the deployed products. Servers and products deployed on the movable platform are capable of two-way communication, allowing access from remote locations to remotely diagnose the products, and uploading information to the server for viewing by related parties.

### CITATION LIST

### Patent Literature

PTL 1: JP2003-271758A

### SUMMARY OF INVENTION

### Technical Problem

In PTL 1, since data is centralized in a central server, it is not possible to share data of which disclosure is restricted at each base. Additionally, it is necessary to select publicly available data at each base, and when this selection is not performed sufficiently, the data is exposed to security risks when uploading the data to the central server. Additionally, when not only data needed by another base but also all publicly available data is uploaded, the central server will be required to have enormous processing power to withstand the processing of large amounts of data.

In this way, in the technology of the related art, it takes time to upload and download data related to semiconductor manufacturing, and a server capacity is also uneven, so it was common for each base to have a server to manage.

An object of the present invention is to provide a technology that makes it possible to access another base from an own base and acquire only necessary data, regarding publicly available data of a device group including a semiconductor manufacturing device in a base other than the own base.

### Solution to Problem

In order to solve the above-described problems, one of the representative base collaboration systems of the present invention is a base collaboration system that accesses a second base different from a first base from the first base where a first computer and a second computer are disposed, and acquires published data of the second base, in which an arrival route to reach the published data is set by the first computer, where a device on the arrival route is permitted to communicate with the published data, and the published data is accessed by the second computer, in which a server in the first base has an area where the published data is stored, where the second computer copies the published data to the area or refers to the published data, and in which communication between a base other than the first base and the area is prohibited by the first computer.

### Advantageous Effects of Invention

According to the present invention, it is possible to access another base from an own base and acquire only necessary data, regarding publicly available data of a device group including a semiconductor manufacturing device in a base other than the own base.

Problems, configurations, and effects other than those described above will be made clear by description in the following description of embodiments.

### BRIEF DESCRIPTION OF DRAWINGS

FIG. 1 is a diagram illustrating a configuration of a base collaboration system using a platform and a device group including a semiconductor manufacturing device.

FIG. 2 is a diagram illustrating a flow of a user's work in the base collaboration system of FIG. 1.

FIG. 3 is a diagram illustrating an example of a case where an etching demonstration is performed to a customer using the base collaboration system in a flowchart of FIG. 2.

FIG. 4 illustrates a flowchart when a BI tool is used when deriving a progress management index in FIG. 3 from public data.

FIG. 5 is a diagram illustrating details of data processing up to extraction of the progress management index.

FIG. 6 is a diagram illustrating differences in configurations of a server and a mirror server with respect to the base collaboration system of FIG. 1.

### DESCRIPTION OF EMBODIMENTS

In the present disclosure, a “base” refers to a location where a predetermined activity is performed. For example, the term “production base” refers to a location where facilities such as production devices are located and where production and activities related to the production can be carried out. Specific examples of the bases include corporate offices, research institutes, production factories, and the like.

Also, “accessing” refers to reaching information possessed by a target object and acquiring information.

A base collaboration system according to the present invention has a platform that includes a gateway computer 102 with a data collection program, a data route setting computer 103, and a communication network with various databases (databases provided in a server 104, a base B mirror server 105, and a base C mirror server 109).

### First Embodiment

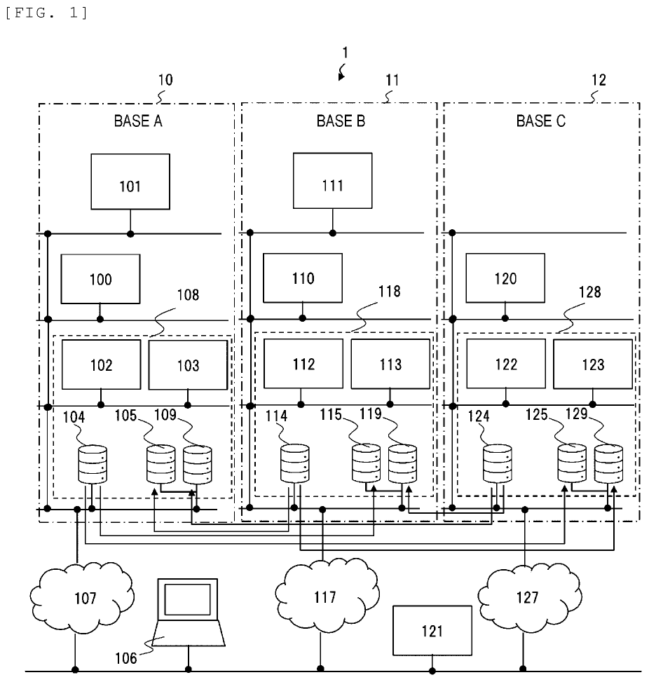

A first embodiment of the present invention will be described below with reference to FIG. 1. FIG. 1 is a diagram illustrating a configuration of a base collaboration system 1 using a platform and a device group including a semiconductor manufacturing device. The base collaboration system 1 makes it possible to access a second base different from a first base from the first base where a first computer (hereinafter also referred to as a “data route setting computer”) and a second computer (hereinafter also referred to as a “gateway computer”) are disposed and to acquire published data (hereinafter also referred to as “public data”) of the second base. The gateway computer functions as an access computer that makes it possible to access a base other than a base where a communication network including the gateway computer is located. Further, the platform includes the first computer within the first base, the second computer within the first base, and a server within the first base. Also, the platform accesses the second base different from the first base from the first base and acquires the published data of the second base. A configuration of the system will be described below.

### System Configuration

The system 1 includes bases A to C. The base A has a communication network 10. The base B has a communication network 11. The base C has a communication network 12. The communication networks 10 to 12 are independent communication networks limited within a range of each base, and in principle, communication is limited within the communication network at each base. Further, the first base is connected to the second base and the third base via a network. In the following description, the first base is the base A, the second base is the base B, and the third base is the base C, but the present disclosure is not limited thereto. It is also possible that the first base is the base A, the second base is the base C, and the third base is the base B. Specifically, Internet 107 and Internet 117 are provided between the base A and the base B. The Internet 117 and Internet 127 are provided between the base B and the base C. The Internet 107 and the Internet 127 are provided between the base A and the base C. The Internet is illustrated as an example of a network, and the present disclosure is not limited to the Internet. It is possible to select an appropriate communication means from among the communication means and apply the appropriate communication means as the network of the present disclosure.

In the communication network 10 in the base A, an in-base A user computer 100, a semiconductor manufacturing line computer group 101, the gateway computer 102, the data route setting computer 103, the server 104, the base B mirror server 105, and the base C mirror server 109 are connected to each other so as to be able to communicate with each other. Among these, a communication network formed by the gateway computer 102, the data route setting computer 103, the server 104, the base B mirror server 105, and the base C mirror server 109 is called a platform 108.

Also, in the communication network 11 in the base B, an in-base B user computer 110, a semiconductor manufacturing line computer group 111, a gateway computer 112, a data route setting computer 113, a server 114, a base A mirror server 115, a base C mirror server 119 are connected to each other so as to be able to communicate with each other. Among these, a communication network formed by the gateway computer 112, the data route setting computer 113, the server 114, the base A mirror server 115, and the base C mirror server 119 is called a platform 118.

Also, in the communication network 12 in the base C, an in-base C user computer 120, a gateway computer 122, a data route setting computer 123, a server 124, a base A mirror server 125, and a base B mirror server 129 are connected to each other so as to be able to communicate with each other. Among these, a communication network formed by the gateway computer 122, the data route setting computer 123, the server 124, the base A mirror server 125, and the base B mirror server 129 is called a platform 128.

In the following description, descriptions of common configurations may be omitted.

The in-base A user computer 100 is connected to devices located within the communication network 10 in the base A. A user at the base A can access the semiconductor manufacturing device, the server, and the like located within the base A by using the in-base A user computer 100.

In the first base or the second base, a device group including the semiconductor manufacturing device, a semiconductor inspection device, or a semiconductor measurement device is disposed. Specifically, the semiconductor manufacturing line computer group 101 controls the semiconductor manufacturing devices and the like that make up a manufacturing line in a semiconductor manufacturing factory, for example, when there is the semiconductor manufacturing factory in the base A. The semiconductor manufacturing line computer group 101 controls the semiconductor manufacturing devices based on a processing recipe regarding process sequences and control parameters, and acquires data indicating a result of processing performed by the semiconductor manufacturing devices. The acquired data is sent to the server 104 via the gateway computer 102. Details will be described below. In the first embodiment, a semiconductor manufacturing line, particularly a manufacturing line including an etching device, will be described. Further, the semiconductor manufacturing line computer group 10 is not limited to being configured by a plurality of computers. The semiconductor manufacturing line computer group 101 may be configured by one computer.

Further, in the server within the base, a device ID and a file extension of output data are stored as a device master. Specifically, the semiconductor manufacturing line computer group 101 allocates the device ID to each semiconductor manufacturing device, manages the file extensions of the output data output from the semiconductor manufacturing device in association with each device ID, and stores the file extensions in the server 104 as the device master. Examples of the file extensions include “.txt” indicating text data, “. gif” indicating image data, and “.csv” indicating a csv file.

The semiconductor manufacturing line includes at least one of the semiconductor manufacturing device, the semiconductor inspection device, and the semiconductor measurement device. A device group including at least one of the semiconductor manufacturing device, the semiconductor inspection device, and the semiconductor measurement device is set at at least one of a plurality of the bases. Further, the semiconductor manufacturing device may include, in addition to the etching device, a plasma CVD device, an ashing device, a surface modification device, and the like. Although the base A is assumed to be the semiconductor manufacturing factory, the present disclosure is not limited to this. The base A may be a line for development or a line for prototyping.

The gateway computer 102 has a function of relaying data exchange between the in-base A user computer 100, the semiconductor manufacturing line computer group 101, and a server group (the server 104, the base B mirror server 105, and the base C mirror server 109). The gateway computer 102 has a data collection program that refers to the device master and collects, from the semiconductor manufacturing line computer group 101, only data associated with a device ID and data extension that match the device ID and the data extension indicated in the device master. When there is a request to access the semiconductor manufacturing line computer group 101 from the in-base A user computer 100, the gateway computer 102 acquires data from the semiconductor manufacturing line computer group 101 based on the data collection program.

Also, when accessing the server group (the server 104, the base B mirror server 105, and the base C mirror server 109), the gateway computer 102 permits access to the server group based on a user ID identified by the in-base A user computer 100, and the like.

When the route setting computer 103 connects to the communication network 11 in the base B or the communication network 12 in the base C to acquire data, an arrival route, which is a route to reach the public data on the server in each base, is set by the gateway computer. Further, a device on the arrival route is permitted to communicate with the public data, and the route setting computer 103 adds the gateway computer 102 to a public data disclosure range. As a result, the public data is accessed by the gateway computer 102. In the base collaboration system 1, data acquisition may be permitted between the communication network 10 and the communication network 12. The route setting computer 103 manages the data acquisition between the communication networks. Details of the functions of the route setting computer 103 will be described below.

The server 104 presents data in response to a request from the in-base A user computer 100. Further, the server 104 stores data sent from the device master and the semiconductor manufacturing line computer group 101. Although an example is illustrated in which the server 104 is configured by one device, the present disclosure is not limited thereto. The server may be configured to be separated into a database server, an application server, a WEB server, and the like for each function.

The base B mirror server 105 is basically a server that has the same functions and data as the server 114 of the base B. The base C mirror server 109 is basically a server that has the same functions and data as the server 124 of the base C.

In this way, the mirror server in the base A has an area within the base A where public data of a base other than the base A is stored. Although the base B mirror server 105 and the base C mirror server 109 are described as separate servers, the present disclosure is not limited thereto. The mirror server may be one server. Further, the server 104, the base B mirror server 105, and the base C mirror server 109 may be configured by one server. It is also possible to configure a single server in which there are respectively provided an area for storing data as the server 104, an area for storing data as the base B mirror server 105, and an area for storing data as the base C mirror server 109. Further, the data stored in the server (the server 104, the base B mirror server 105, and the base C mirror server 109) within the first base includes data collected from the device group or data obtained by processing the data collected from the device group.

The communication network 11 in the base B has the same configuration as the communication network 10 in the base A.

Further, the communication network 12 in the base C has the same configuration as the communication network 10 in the base A, except that there is no configuration corresponding to the semiconductor manufacturing line computer group 101. The base C is assumed to be, for example, a research institute without the manufacturing line or a design center that performs design.

The communication network 10 in the base A, the communication network 11 in the base B, and the communication network 12 in the base C are each independent communication networks. On the other hand, a remote monitor 106 and an out-base user computer 121 can communicate with the communication network 10 via the Internet 107. Further, the remote monitor 106 and the out-base user computer 121 can communicate with the communication network 11 via the Internet 117. Additionally, the remote monitor 106 and the out-base user computer 121 can communicate with the communication network 12 via the Internet 127.

### When Acquiring Data at Own Base

In the base A, a processing recipe for performing an etching process is input to the semiconductor manufacturing line computer group 101 and executed. After execution, the etching device transmits an instruction value according to a content of the recipe to each device unit in the etching device, and the etching process is performed. The processing recipe in which the etching process is performed is stored in the semiconductor manufacturing line computer group 101.

The etched wafer is transported to the semiconductor inspection device, a semiconductor analyzer, or a semiconductor analysis device, and each measurement recipe is input to the semiconductor manufacturing line computer group 101 to perform a predetermined measurement. Data indicating a measured result is stored in the semiconductor manufacturing line computer group 101.

The data route setting computer 103 determines whether data including the processing recipe and the measurement result stored in the semiconductor manufacturing line computer group 101 can be accessed, and defines the flow of data (routing). For example, the data route setting computer 103 selects public data and private data from among the data stored in the server 104. The public data is data that is made public when a request is made from an out-base A device. The out-base A device is, for example, the in-base B user computer 110 and the in-base C user computer 120. It can also be said that the public data is data that can be accessed by the request from devices other than the gateway computer. Further, the private data is data that is prohibited from being made public when a request is made from the out-base A device.

A method of setting the public data or the private data is not limited to this. For example, the private data can be set to be made public only by the requests from the gateway computer 112 in the base A and the gateway computer 122 in the base B.

Further, the data route setting computer 103 performs routing and defines a data route. Regarding the public data, the route through which data is transmitted when a request is made from the communication network 11 and the communication network 12 is defined. For example, the data route setting computer 103 can permit the gateway computer 112 and the gateway computer 122 to access the communication network 10. Regarding the private data, the data route may be selected by a user, or may be dynamically selected by the data route setting computer 103.

The gateway computer 102 executes the data collection program, accesses the device master, and acquires data permitted by the device master from the device group. The permitted data is stored in the server 104 within the base A. The gateway computer 102 executes a built-in data collection program, accesses the semiconductor manufacturing line computer group 101, and collects data on the semiconductor manufacturing device according to the defined data route. The collected data is stored in the server 104.

The server 104 manages the data collected by the gateway computer 102 by dividing the collected data into the public data and the private data. A management method is not limited to a method of managing data by dividing the data into the public data and the private data. The management method may be a method of managing data by dividing the data into categories or levels within the database possessed by the server 104. For example, it is assumed that the categories are categorized by each device such as the semiconductor manufacturing device, the semiconductor inspection device, the semiconductor analyzer, or the semiconductor analysis device, or by each manufacturing line lot. Further, as the levels, it is assumed that a separate information management level is provided, such as limiting users who can access the data within the base A, even for etching and private data.

The server 104 also registers authentication information for logging into the platform 108. The server 104 receives user input via the in-base A user computer 100, registers a user ID and a password, and performs authentication upon login.

The user logs into the platform 108 from the in-base A user computer 100 based on the authentication information, and selects the device ID or the file extension registered in the device master within the platform. The server 104 presents data specified by the identified device ID or file extension to the user.

As described above, within the base A, the user can acquire data (the public data and the private data) at the base A via the in-base A user computer 100. When acquiring data at the base B via the in-base B user computer 110 in the base B, and when acquiring data at the base C via the in-base C user computer 120 in the base C, it is possible to perform in the same way as in the base A.

### When acquiring Public Data of Another Base

The server 104 registers user IDs and passwords of the gateway computer 112 and gateway computer 122 as authentication information for logging into the platform 108. The server 114 also registers user IDs and passwords of the gateway computer 102 and gateway computer 122 as authentication information for logging into the platform 118. The server 124 also registers user IDs and passwords of the gateway computer 102 and gateway computer 112 as authentication information for logging into the platform 128.

For example, when the gateway computer 102 of the base A accesses the platform 118 in the base B, even when acquiring data classified as public data of the base B, the user ID and the password of the gateway computer 102 of the base A need to be registered in the platform 118 in the base B. In other words, when the gateway computer 102 accesses the server 114 within the base B, authentication information of the platform 118 that includes the server within the base B is required. For example, when a request is made to access the public data of the base B, the gateway computer 112 in the base B allows the base A to access the public data based on the request when the authentication information at the time of making the request matches the registered authentication information. In this way, by using the authentication information of the gateway computer in another base for logging into the platform in one base, routes that can be accessed from outside the communication network are limited to those that go through the gateway computer, so it is possible to prevent unauthorized access to data within the platform from external networks.

A case in which data is allowed to be acquired by an external user will be specifically described. For example, when acquiring the public data of the base B from the base A, the data route setting computer 113 in the base B sets the gateway computer 102 in the base A in a public data disclosure range of the server 114 in the base B.

The gateway computer 102 has a file copy program in which public data is copied to an area where the public data is to be stored or the public data is referred to by the gateway computer 102. The gateway computer 102 in the base A passes the authentication of the platform 118 via the Internet 107, and accesses the server 114 in the base B. The gateway computer 102 executes the program to copy or refer to and acquire the public data of the base B.

The acquired public data of the base B passes the authentication of the platform 108 in the base A, and is stored in the base B mirror server 105. Further, communication between a base other than the first base and an area where the public data is to be stored that is possessed by the server within the first base is prohibited by the data route setting computer within the first base. Specifically, the base B mirror server 105 is prohibited from communicating with the outside of the base A by the data route setting computer 103. By doing this, the acquired public data will be handled only within the base A, and the public data of the base B stored in the base B mirror server 105 can be viewed and edited in the base A.

The same system as in the base A is introduced at another base, including the base B or the base C where a device does not exist, and it is possible to acquire, view, and edit public data of the other base without security risks.

The public data disclosure range can be set to gateway computers in the plurality of bases, or only to a gateway computer in a specific base.

### Modification Example of First Embodiment

It is also possible to permit access to the platform even when a request is made from a device that is not included in the communication network in the base. For example, the server 104 registers the user IDs and the passwords of the remote monitor 106 and the out-base user computer 121 as authentication information for logging into the platform 108. The gateway computer 102 can also be configured to acquire data of various servers within the platform 108 when a request is made from the remote monitor 106 and the out-base user computer 121.

### Operation/Effect

In the first embodiment, the public data and the private data are selected by the route setting computer, and data to be uploaded from one base to the mirror server of another base is limited. Since an amount of the data to be uploaded is reduced, data obtained from the other base can be used at another base while reducing the processing power of the mirror server. Additionally, when a request is made to acquire data from outside the own base, only access via the gateway computer is permitted. When a request is made from a device for which authentication information is not registered, access to data is prohibited, thereby making it possible to reduce security risks.

### Second Embodiment

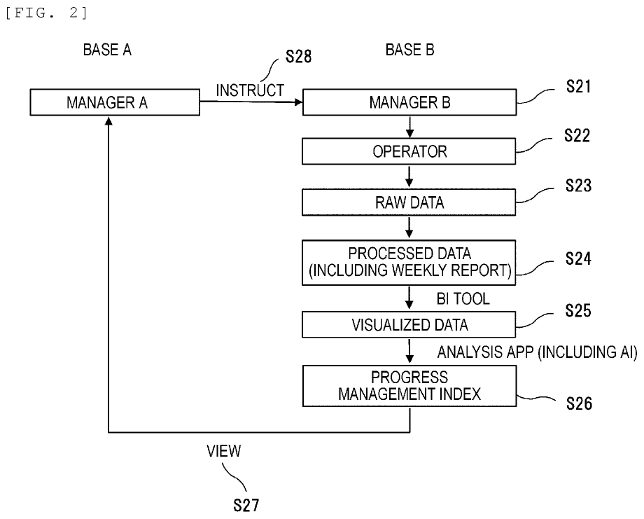

A second embodiment of the present invention will be described with reference to FIG. 2. FIG. 2 is a diagram illustrating a flow of a user's work in the base collaboration system 1 of FIG. 1. This is an example in which a manager A of the base A gives an instruction to a manager B of the base B.

First, in the base B, the manager B gives an instruction for semiconductor processing to an operator (step S21). Based on the instruction, the operator inputs the operating conditions of the semiconductor manufacturing device into the semiconductor manufacturing line computer group 111 and performs the semiconductor processing (step S22), and then the operator acquires raw data (data before editing, original data) indicating a processed result (step S23). The raw data is acquired by the semiconductor manufacturing line computer group 111 and set as public data or private data by the route setting computer 113.

The raw data is subjected to secondary processing, for example, by the server 114, and processed into a form that can be read by a Business Intelligence (BI) tool. The processed data may include text data such as a weekly report showing the operator's impressions. In response to a user's request obtained via the in-base B user computer 110, the processed data is read by the BI tool provided by the server 114, for example, and is converted into visualized data such as a graph (step S25).

Next, a progress management index of the work is extracted from the visualized data. For example, the progress management index of the work is extracted from the visualized data by the manager B who is presented with the visualized data, or the progress management index is derived by an analysis application including AI provided by the Server 114 (step S26).

The route setting computer 113 selects the data including the progress management index as the public data, and sets the gateway computer 102 in the base A in the disclosure range. The data including the progress management index is acquired by the gateway computer 102 and recorded in the base B mirror server 105. The manager A uses the in-base A user computer 100 to view the progress management index and understand a progress of the work (step S27). When there is a problem with the progress of the work, the manager A gives an instruction to the manager B again based on the progress management index (step S28).

### Operation/Effect

Among the data acquired in the base B, the data including the progress management index is selected as the public data. The size of the data including the progress management index is compressed compared to the raw data. Since an amount of the data to be uploaded to the base B mirror server 105 can be reduced, data obtained from another base can be used at another base while reducing the processing power of the mirror server. Further, since the progress management index can be checked at the other base, it becomes possible for the manager of one base to manage the progress of the other base.

### Third Embodiment

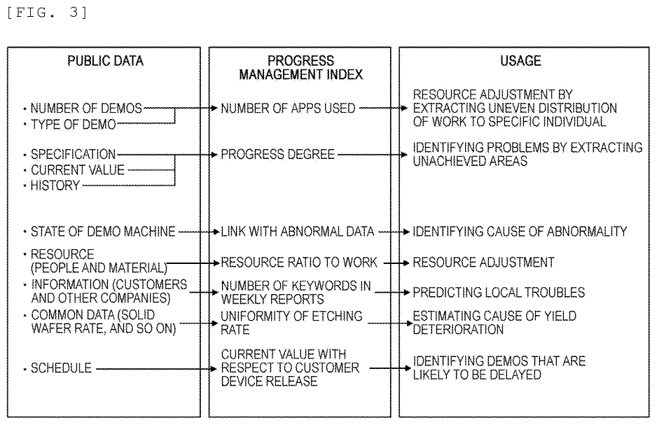

FIG. 3 is a diagram illustrating an example of a case where an etching demonstration is performed to a customer using the base collaboration system in a flowchart of FIG. 2. A type of a progress management index derived from public data and a usage example of the progress management index are illustrated.

In addition to the raw data acquired from the semiconductor manufacturing device, various types of data are used, including processed raw data, the visualized data, and statistical data which is obtained by performing statistical processing on the raw data and the processed data and which indicates the characteristics of the semiconductor manufacturing line in the base. Usage examples of these will be described.

As the public data, the number (“number of demos” in the figure) of etching customer demonstrations and a type (“type of demo” in the figure) of demonstration are counted based on login information using an application (hereinafter also referred to as an “app”). As a result, the number of apps used by each user is derived as the progress management index. By viewing the number of apps used, it is possible to check whether the work is unevenly distributed to a specific user, and if so, to review the work distribution. The customer demonstration refers to semiconductor manufacturing performed by a request of a customer such as a device manufacturer. The number of demos and the type of demo can be extracted, for example, based on an operation history of operating the semiconductor manufacturing line computer group. For example, a user operating the semiconductor manufacturing line computer group 101 logs into the in-base A user computer 100 and acquires data output from the semiconductor manufacturing line computer group 101. Therefore, by associating the number of demos and the type of demo with the login information, it is possible to understand an amount of work for each user.

In addition, a specification value required by the customer, a current specification value (“current value” in the figure) after the demonstration, and a history of the demonstration are counted as the public data, and a progress degree is calculated, which indicates a ratio of the current specification value to the specification value required by the customer. From this progress degree, it is possible to analyze unachieved areas and to extract problems that are obstacles during demonstrations. The specification value required by the customer is stored in the server 104 by the in-base A user computer 100, for example. Further, the current specification value after the demonstration can be adopted, for example, a value based also on data indicating results output from a semiconductor analysis device or a semiconductor analyzer.

In addition, a state of a demo machine is specified as the public data, and a state of the demo machine when abnormal data is generated is linked in chronological order from the state of the demo machine. This makes it possible to specify the state of the demo machine when the abnormal data is generated, and to specify the cause of the abnormality. The demo machine is connected to the semiconductor manufacturing line computer group, and data monitoring an operating status of the demo machine is acquired by the semiconductor manufacturing line computer group.

In addition, people who are work resources and materials that are demo resources are counted as the public data, and a resource ratio to the work is calculated. This allows resource adjustment. People resources can be calculated from, for example, the operation history of the semiconductor manufacturing line computer group and the login history of the in-base A user computer 100. Regarding material resources, for example, it is possible to calculate an amount of material consumed by understanding the operation of a semiconductor manufacturing device from data output from a semiconductor manufacturing line computer group.

In addition, information (customers and other companies) is analyzed as the public data, and the number of keywords in weekly reports is counted. This makes it possible to determine that demonstration related to frequently occurring specific keywords is important. Information regarding customers and other companies accompanies processing recipes when performing customer demonstrations, for example. The server 104 collects the information regarding customers and other companies, and counts the number of times the information regarding customers and other companies appears in weekly reports.

In addition, common data such as an etching rate (“solid wafer rate” in the figure) of a single film wafer is adopted as the public data. Here, solid wafer rates are collected and analyzed for components commonly included in customer wafers. As the progress management index, for example, uniformity of the etching rate is calculated. This makes it possible to specify the cause of yield deterioration. Common data can be extracted using specific manufacturing conditions as a key, for example, in the semiconductor manufacturing line computer group.

Schedules are analyzed as the public data to specify a current position with respect to release (for example, scheduled release) of the customer's device. This makes it possible to identify demonstrations that are likely to be delayed. For example, a schedule including due dates is stored in the server 104 by a user. In the semiconductor manufacturing line computer group 101, the server 104 calculates an end schedule of the demonstration based on the remaining number of scheduled processing recipes and the scheduled execution time of the processing recipes, and presents a comparison with the schedule.

### Operation/Effect

By extracting the progress management index from the public data during the customer demonstration, it becomes possible to address problems that may occur during the customer demonstration.

### Fourth Embodiment

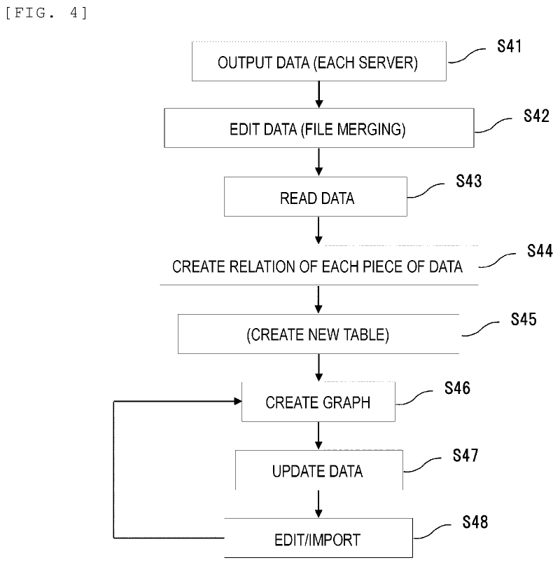

FIG. 4 illustrates a flowchart when a BI tool is used when deriving the progress management index in FIG. 3 from public data.

First, a server in each base collects data on a semiconductor device. The server periodically outputs and stores a tsv file including various device information from the semiconductor manufacturing line computer group via the gateway computer (step S41).

Then, the server edits data of the above-described tsv file (step S42). By vertically merging periodically acquired files, the server processes the periodically acquired files into information that includes changes over time. The server causes the BI tool to read the processed information (step S43). When there are a plurality of file types, columns common to each file are linked to create a relation (step S44), thereby building a mutual relationship and linking each data. Since linking may be difficult depending on the type of graph, a new table is created on the BI tool as necessary (step S45). The linked data or the new table is read and a graph is created (step S46). When a new tsv file is generated, the server adds the new tsv file to the existing file and causes the BI tool to read the new tsv file, and graph data is updated (step S47). The progress management index is derived by editing and incorporating the updated data (step 48). By repeating this work (repeating steps S46 to S48), the graph is updated, and the progress management index is extracted from the updated graph.

### Operation/Effect

By providing the server with the BI tool, when there is a progress on the semiconductor manufacturing line, it becomes possible to update a progress management index and present the updated progress management index to the user. Since the user can understand changes in the progress management index, it becomes possible to allocate work within a base and between the bases in real time.

### Fifth Embodiment

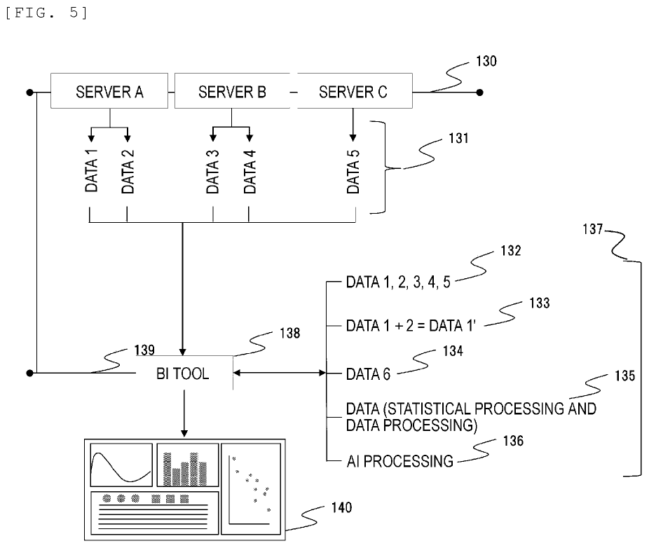

FIG. 5 is a diagram illustrating details of data processing up to extraction of the progress management index. The communication networks 10 to 12 are independent communication networks, and are basically so-called closed networks that cannot be accessed directly from outside the communication network. Here, the communication networks 11 to 13 are displayed as a closed network 130, and details of data processing will be described. Servers A to C in FIG. 5 are assumed to be, for example, the server 104 in the base A, the base B mirror server 105, and the base C mirror server 109.

In FIG. 5, the closed network 130 shows that a server on a closed network is connected to a semiconductor manufacturing device, and can collect information such as a state and a setting of the device and output the collected information to a user.

The server A outputs data 1 and data 2, the server B outputs data 3 and data 4, and the server C outputs data 5. A collection of data from the data 1 to the data 5 is called an output data file 131. After the data in the output data file 131 from the server is read into a BI tool, statistical processing, data processing, AI processing methods, and data processing of data set 137 that is a result after processing are executed on a data table recognized on the BI tool, and visualization and data analysis are performed.

Although a data table A 132 to a data table E 136 are listed as examples of data processing, a wide variety of processing can be realized by creating program scripts.

The data table A 132 created from the output data file 131 read on the BI tool represents a case where each of the data 1 to the data 5 is used individually. In addition, the new data table B 133 created by combining a part of the data 2 with the data 1 shows a case where new data 1′ is created by adding, to the data 1, a part that is not present in the data 1 but exists in the data 2.

Further, the new data table C 134 created by partially combining existing data files indicates new data 6 is created.

Also, the program script on the BI tool and the data table D 135, which is a result of statistical processing or processing of data by referring to the program script, show how to process each piece of data using the statistical processing or data processing program script set in advance on the BI tool. As a result, new data can be generated and analyzed.

In addition, the data table E 136 is illustrated as a method of performing AI processing to determine the above-described data trends and extract abnormal points.

A BI tool 138 can receive the above-described data tables and visualize the data tables to obtain, for example, graphs and tables on a progress management screen 140 presented by the server.

### Operation/Effect

Since the BI tool is software that operates on a server or personal computer, a device on which the BI tool operates exists on the Internet 139 and is in a state where the device can access the data files output by the server on the closed network 130. Therefore, information within the closed network can be analyzed using external information via the Internet. Further, by intervening AI, it becomes possible to perform various information analyses such as information merging and trend extraction. For example, a BI tool can be used for an in-base user computer, a remote monitor, an out-base user computer, and the like.

### Sixth Embodiment

A sixth embodiment differs from the base collaboration system 1 of the first embodiment (FIG. 1) in that the configurations of the server and the mirror server are changed. In the following description, differences from the first embodiment will be described, and the similar or equivalent components as in the first embodiment described above will be denoted by the same reference numerals, and the description thereof will be simplified or omitted.

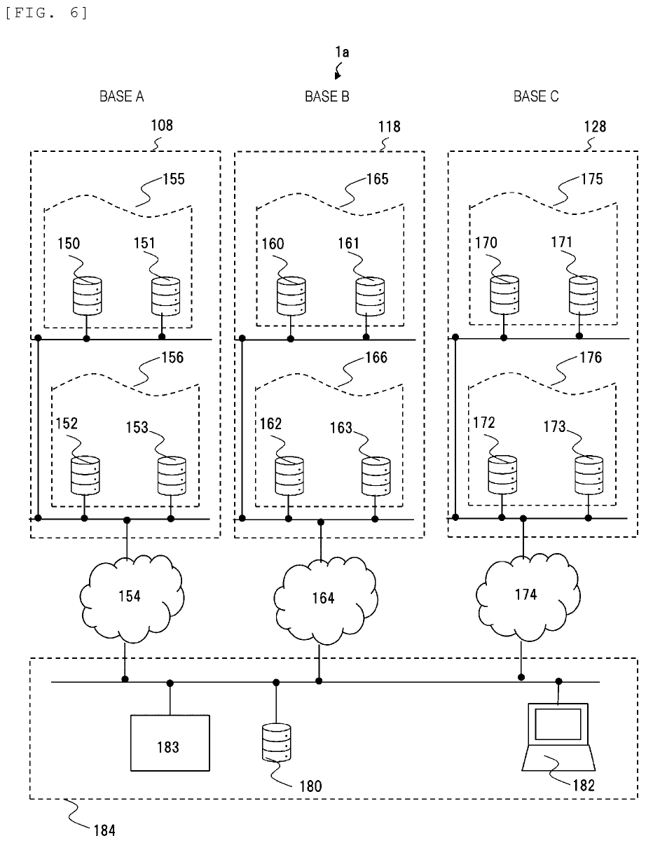

FIG. 6 is a diagram illustrating differences in the configurations of the server and mirror server with respect to the base collaboration system of FIG. 1. A non-sharable server 150 and a sharable server 152 in a base collaboration system 1a of FIG. 6 correspond to the server 104 in the base collaboration system of FIG. 1. A non-sharable server 160 and a sharable server 162 in the base collaboration system 1a of FIG. 6 correspond to the server 114 in the base collaboration system of FIG. 1. A non-sharable server 170 and a sharable server 172 in the base collaboration system 1a of FIG. 6 correspond to the server 124 in the base collaboration system of FIG. 1.

The network within the platform in the second base is divided into a first network (hereinafter also referred to as an “in-base public environment”) that can communicate with a base other than the second base, and a second network (hereinafter also referred to as an “in-base private environment”) that cannot communicate with the base other than the second base. Specifically, in the base A, an environment that is divided into an in-base private environment 155 and an in-base public environment 156 is set within the platform 108. The in-base private environment 155 is an environment in which communication with an outside of the base A is not possible, and the in-base public environment 156 is an environment in which the communication with the outside of the base A is possible. Similarly, in the base B, an environment is divided into an in-base private environment 165 and an in-base public environment 166 within the platform 118. In the base C, an environment is divided into an in-base private environment 175 and an in-base public environment 176 within the platform 128.

In the in-base private environment 155, a non-sharable server 150, which is a server that stores data that cannot be shared with the outside of the base A, and a non-sharable mirror server 151, which is a mirror server that stores data that cannot be shared with the outside of the base A among the data acquired from the base B and the base C, are disposed. The non-sharable server 150 and the non-sharable mirror server 151 are prohibited from accessing from outside by the data route setting computer 103, ensuring the confidentiality and safety of the stored data.

The published data is stored in a database connected to the first network, and the data stored in the database connected to the first network and published is stored in a database connected to a cloud network. Specifically, in the in-base public environment 156, the sharable server 152, which is a server that stores data (for example, public data) that can be shared with the outside of the base A, and a sharable mirror server 153, which is a mirror server that stores data that can be shared with the outside of the base A, out of the data acquired from the base B and base C, are disposed. The sharable server 152 and the sharable mirror server 153 are permitted to communicate with the outside of the base A by the data route setting computer 103, and it becomes possible for the gateway computer 102 to upload data that can be supplied to an inter-base common cloud environment 184 that connects a plurality of bases via Internet 154.

The non-sharable server 160, a non-sharable mirror server 161, the sharable server 162, and a sharable mirror server 163 in the base B, and the non-sharable server 170, a non-sharable mirror server 171, the sharable server 172, and a sharable mirror server 173 in the base C have the similar system configuration as the non-sharable server 150, the non-sharable mirror server 151, the sharable server 152, and the sharable mirror server 153 of the base A, respectively. The sharable data stored in the sharable server 162 and sharable mirror server 163 of the base B can be uploaded to the inter-base common cloud environment 184 via Internet 164. The sharable data stored in the sharable server 172 and sharable mirror server 173 of the base C can be uploaded to the inter-base common cloud environment 184 via Internet 174.

The gateway computer 102 also has a file copy program that stores sharable data in a database in the inter-base common cloud environment 184. By executing this program, in the inter-base common cloud environment 184, sharable data uploaded from each base is stored in a database within a cloud server 180, and the data stored in the cloud server 180 can be accessed from a remote monitor 182.

It is also possible to dispose a visualization tool or data analysis application 183 in the inter-base common cloud environment 184, and to utilize the visualization tool or the data analysis application 183 for progress management of the base collaboration system 1a. The visualization tool or data analysis application 183 receives public data as input, and the progress of semiconductor device manufacturing is visualized or analyzed based on the public data.

### Operation/Effect

As described above, by storing highly confidential data in an area that cannot be shared with the outside of the base, a private network environment (non-public) can be constructed. Further, since the private environment cannot communicate with the outside of the base, it is possible to prevent, for example, highly confidential customer data from leaking outside the base.

Additionally, in an in-base private environment, there is no unnecessary access from outside and the amount of access can be managed, thereby making it possible to maintain constant communication speed and stability. In order to ensure the security of highly confidential data, dividing into an environment that can be accessed from the outside and an environment that cannot be accessed from the outside can be used in various ways. For example, when a manufacturing base of a manufacturer that manufactures semiconductors is one of the configurations of the base collaboration system 1a, in making the public data sharable and providing the public data to customers such as trading companies and industrial equipment manufacturers, by using the big data and the public data owned by the customer as the input conditions for the first to fifth embodiments, it becomes possible to provide feedback to the manufacturing progress management on the manufacturer side.

Further, by using the visualization tool or data analysis application 183, data between bases can be compared. This allows the manager to manage progress between bases and issue instructions to each base via the remote monitor 182. Additionally, people outside the base can also manage progress.

In the above embodiments, a computer is used for the description, but instead of a computer terminal, a virtual area, a server, or a mobile terminal may be used. Further, as for the communication method in the communication network within the base, it is also possible to employ communication methods such as SMB communication, FTP communication, NFS communication, and the like. Further, it is also possible to apply a computer to the remote monitor.

Further, although the above embodiments are described using an etching device as an example of a semiconductor manufacturing device, similar operational effects can be obtained for other manufacturing devices such as a plasma CVD device, an ashing device, a surface modification device, and the like.

Although the embodiments of the invention are described above, the invention is not limited to the above-described embodiments, and various changes can be made without departing from the gist of the invention.

### OTHER ASPECTS

Possible aspects of the present invention are described below. However, the invention is not limited to this.

### Aspect 1

A base collaboration system that accesses a second base different from a first base from the first base where a first computer and a second computer are disposed, and acquires published data of the second base, in which
an arrival route to reach the published data is set by the first computer, in which
   a device on the arrival route is permitted to communicate with the published data, and
   the published data is accessed by the second computer, in which
a server in the first base has an area where the published data is stored, in which
   the second computer copies the published data to the area or refers to the published data, and in which
communication between a base other than the first base and the area is prohibited by the first computer.

### Aspect 2

The base collaboration system according to Aspect 1, in which
the first base is connected to the second base and a third base via a network.

### Aspect 3

The base collaboration system according to Aspect 1 or 2, in which
the first base is a base A,
the second base is a base B, and
the third base is a base C.

### Aspect 4

The base collaboration system according to any one of Aspects 1 to 3, in which
the first base is a base A,
the second base is a base C, and
the third base is a base B.

### Aspect 5

The base collaboration system according to any one of Aspects 1 to 4, in which
a network within a platform in the second base is divided into a first network that can communicate with a base other than the second base and a second network that cannot communicate with the base other than the second base,
the published data is stored in a database connected to the first network, and
data stored and published in the database connected to the first network is stored in a database connected to a cloud network.

### Aspect 6

The base collaboration system according to any one of Aspects 1 to 5, in which
in the first base or the second base, a device group including a semiconductor manufacturing device, a semiconductor inspection device, or a semiconductor measurement device is disposed.

### Aspect 7

The base collaboration system according to any one of Aspects 1 to 6, in which
data stored in the server in the first base includes data collected from the device group or processed data obtained by processing the data collected from the device group.

### Aspect 8

The base collaboration system according to any one of Aspects 1 to 7, in which
when the second computer accesses a server in the second base, authentication information for a platform that includes the server in the second base is required.

### Aspect 9

The base collaboration system according to any one of Aspects 1 to 8, in which
the server in the second base stores a device ID and a file extension of output data as a device master,
the second computer acquires data permitted by the device master from the device group, and
the permitted data is stored in the server within the first base.

### Aspect 10

The base collaboration system according to any one of Aspects 1 to 9, in which
a progress of semiconductor device manufacturing is visualized or analyzed based on the published data.

### Aspect 11

A platform that includes a first computer in a first base, a second computer in the first base, and a server in the first base, accesses a second base different from the first base from the first base, and acquires published data of the second base, in which
an arrival route to reach the published data is set by the first computer, in which
   a device on the arrival route is permitted to communicate with the published data, and
   the published data is accessed by the second computer, in which
the server has an area where the published data is stored, in which
   the second computer copies the published data to the area or refers to the published data, and
communication between a base other than the first base and the area is prohibited by the first computer.

### Aspect 12

The platform according to Aspect 11, in which
the first base is connected to the second base and a third base via a network.

### Aspect 13

The platform according to Aspect 11 or 12, in which
the first base is a base A,
the second base is a base B, and
the third base is a base C.

### Aspect 14

The platform according to any one of Aspects 11 to 13, in which
the first base is a base A,
the second base is a base C, and
the third base is a base B.

### REFERENCE SIGNS LIST

1, 1a: base collaboration system
10 to 12: communication network
100: in-base A user computer
101: semiconductor manufacturing line computer group
102: gateway computer
103: data route setting computer
104: server
105: base B mirror server
106: remote monitor
107: Internet
108: platform
109: base C mirror server
110: in-base B user computer
111: semiconductor manufacturing line computer group
112: gateway computer
113: data route setting computer
114: server
115: base A mirror server
117: Internet
118: platform
119: base C mirror server
120: in-base C user computer
121: out-base user computer
122: gateway computer
123: data route setting computer
124: server
125: base A mirror server
127: Internet
128: platform
129: base B mirror server
130: closed network
131: output data file
132: data table A
133: data table B
134: data table C
135: data table D
136: data table E
137: data set
138: BI tool
139: Internet
140: progress management screen
150: non-sharable server
151: non-sharable mirror server
152: sharable server
153: sharable mirror server
154: Internet
155: in-base private environment
156: in-base public environment
160: Non-sharable Server
161: non-sharable mirror server
162: sharable server
163: sharable mirror server
164: Internet
165: private environment of base B
166: public environment of base B
170: non-sharable server
171: non-sharable mirror server
172: sharable server
173: sharable mirror server
174: Internet
175: private environment of base C
176: public environment of base C
180: cloud server
182: remote monitor
183: visualization tool or data analysis application
184: inter-base common cloud environment

1. A base collaboration system that accesses a second base different from a first base from the first base where a first computer and a second computer are disposed, and acquires published data of the second base, wherein
an arrival route to reach the published data is set by the first computer, wherein
a device on the arrival route is permitted to communicate with the published data, and
the published data is accessed by the second computer, wherein
a server in the first base has an area where the published data is stored, wherein
the second computer copies the published data to the area or refers to the published data, and wherein
communication between a base other than the first base and the area is prohibited by the first computer.

2. The base collaboration system according to claim 1, wherein
the first base is connected to the second base and a third base via a network.

3. The base collaboration system according to claim 2, wherein
the first base is a base A,
the second base is a base B, and
the third base is a base C.

4. The base collaboration system according to claim 2, wherein
the first base is a base A,
the second base is a base C, and
the third base is a base B.

5. The base collaboration system according to claim 1, wherein
a network within a platform in the second base is divided into a first network that can communicate with a base other than the second base and a second network that cannot communicate with the base other than the second base,
the published data is stored in a database connected to the first network, and
data stored and published in the database connected to the first network is stored in a database connected to a cloud network.

6. The base collaboration system according to claim 1, wherein
in the first base or the second base, a device group including a semiconductor manufacturing device, a semiconductor inspection device, or a semiconductor measurement device is disposed.

7. The base collaboration system according to claim 6, wherein
data stored in the server in the first base includes data collected from the device group or processed data obtained by processing the data collected from the device group.

8. The base collaboration system according to claim 7, wherein
when the second computer accesses a server in the second base, authentication information for a platform that includes the server in the second base is required.

9. The base collaboration system according to claim 8, wherein
the server in the second base stores a device ID and a file extension of output data as a device master,
the second computer acquires data permitted by the device master from the device group, and
the permitted data is stored in the server within the first base.

10. The base collaboration system according to claim 9, wherein
a progress of semiconductor device manufacturing is visualized or analyzed based on the published data.

11. A platform that includes a first computer in a first base, a second computer in the first base, and a server in the first base, accesses a second base different from the first base from the first base, and acquires published data of the second base, wherein
an arrival route to reach the published data is set by the first computer, wherein
a device on the arrival route is permitted to communicate with the published data, and
the published data is accessed by the second computer, wherein
the server has an area where the published data is stored, wherein
the second computer copies the published data to the area or refers to the published data, and wherein
communication between a base other than the first base and the area is prohibited by the first computer.

12. The platform according to claim 11, wherein
first base is connected to the second base and a third base via a network.

13. The platform according to claim 12, wherein
the first base is a base A,
the second base is a base B, and
the third base is a base C.

14. The platform according to claim 12, wherein
the first base is a base A,
the second base is a base C, and
the third base is a base B.
